(19) United States
(12) Patent Application Publication
(10) Pub. No.: US 2019/0163403 A1
(43) Pub. Date: May 30, 2019

(54) SOLID STATE DRIVE WITH REDUCED HOST OVERSIGHT OF HIGH PRIORITY READ COMMAND

(71) Applicant: Intel Corporation, Santa Clara, CA (US)

(72) Inventors: Aliasgar S. MADRASWALA, Folsom, CA (US); Naveen Vittal PRABHU, Folsom, CA (US)

(21) Appl. No.: 16/264,390

(22) Filed: Jan. 31, 2019

(51) Int. Cl. G06F 3/06; G06F 13/16; G06F 13/40

(52) U.S. Cl. CPC G06F 3/0659; G06F 3/0611; G06F 13/4027; G06F 13/1668; G06F 3/0679

(57) ABSTRACT

A method performed by a non volatile memory is described. The method includes receiving a first command from a controller to perform an operation. The method also includes receiving a second command from the controller to perform a read operation, where, the controller does not send a third command to suspend the operation between the first and second commands.

### FIELD OF THE INVENTION

The field of invention pertains generally to the computing sciences, and, more specifically, to a solid state drive with reduced host oversight of high priority read command.

### BACKGROUND

Presently available non-volatile memories (e.g., flash memories) for solid state drives (SSDs) can suspend a present operation in favor of a high priority read command. However, the SSD controller must first affirmatively suspend the present operation of a non volatile memory (NVM), wait a period of time for the NVM to suspend the operation and then send the high priority read command. The SSD controller's heavy oversight of the NVM in suspending the NVM's operation in favor of the high priority read command results in inconvenience/inefficiency of the SSD controller's internal operations.

### FIGURES

A better understanding of the present invention can be obtained from the following detailed description in conjunction with the following drawings, in which:

FIGS. 1a through 1e show a traditional NVM high priority read process (prior art);

FIG. 2 shows an improved NVM high priority read approach;

FIGS. 3a through 3h detail an embodiment of the improved NVM high priority read process;

FIG. 4 shows an embodiment of SR[0] through SR[2] bits.

FIG. 5 shows different commands that can follow a suspended high priority read;

FIG. 6 shows a non volatile memory;

FIG. 7 shows a computing system.

### DETAILED DESCRIPTION

Current day solid state drive (SSD) devices include a controller to control multiple NVMs within the SSD. The SSD controller is typically implemented with logic circuitry (e.g., dedicated hardwired logic circuitry (including, e.g., one or more state machine logic circuits), programmable logic circuitry (e.g., field programmable gate array (FPGA), programmable logic array (PLA), etc.) and/or logic circuitry designed to execute some form of program code such as SSD firmware (e.g., an embedded processor, embedded controller, etc.). The SSD typically also includes memory coupled to the logic circuitry (e.g., to cache NVM data, to store firmware executed by the controller, etc.).

The SSD controller includes or is otherwise coupled to an external host interface (e.g., a Peripheral Component Interconnect Extended (PCIe) interface, a Non Volatile Memory Express (NVMe) interface, a Serial AT Attachment (SATA) interface, a Universal Serial Bus (USB) interface, etc.) to communicatively couple the SSD with a host system (e.g., a larger computer platform) that uses the NVM storage resources of the SSD.

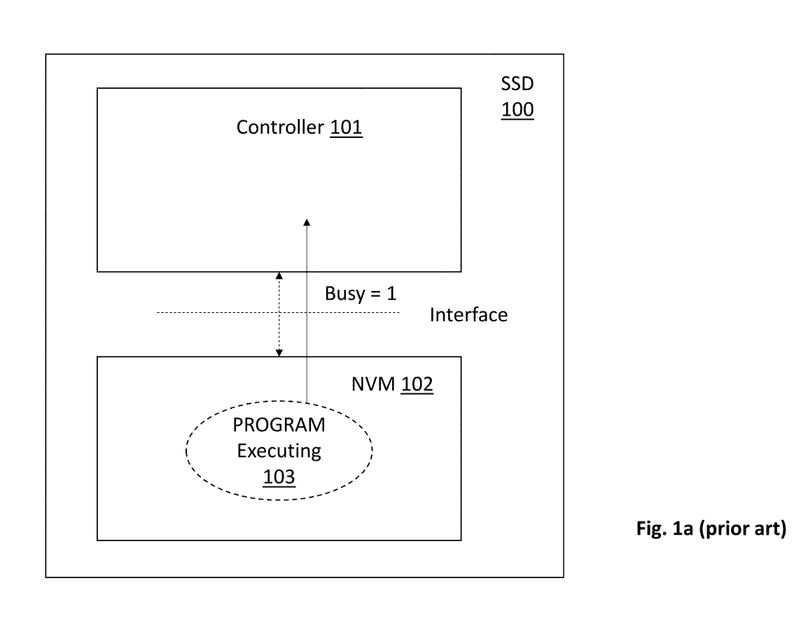

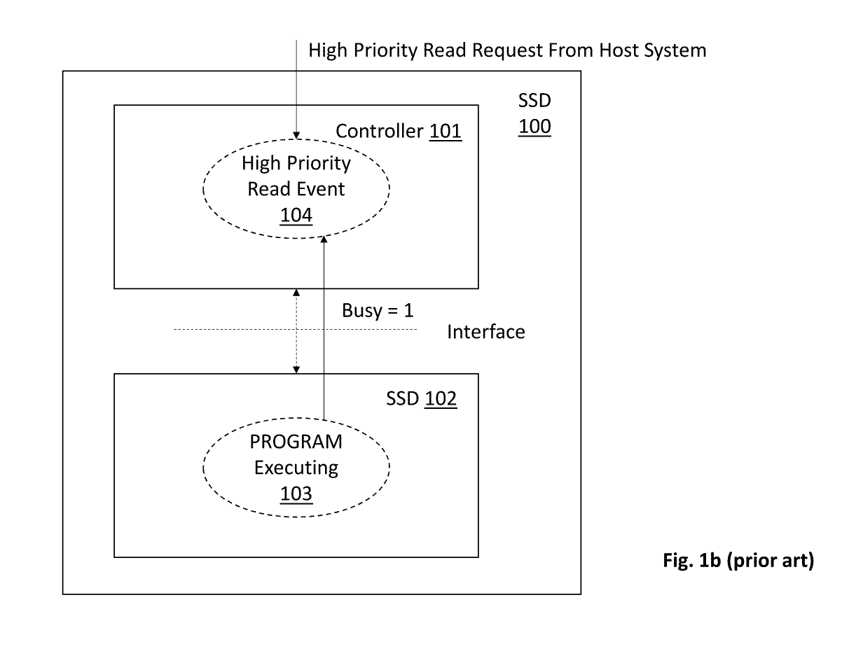

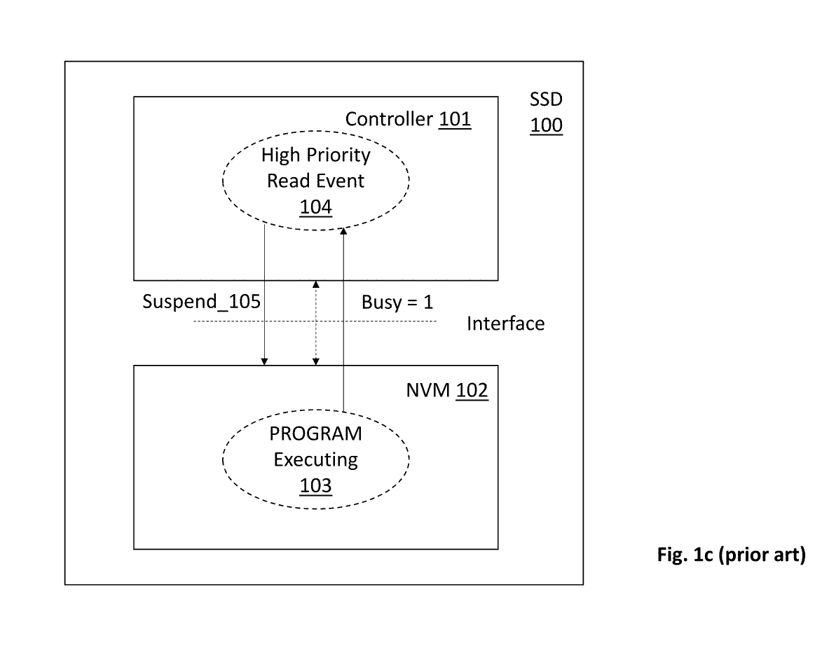

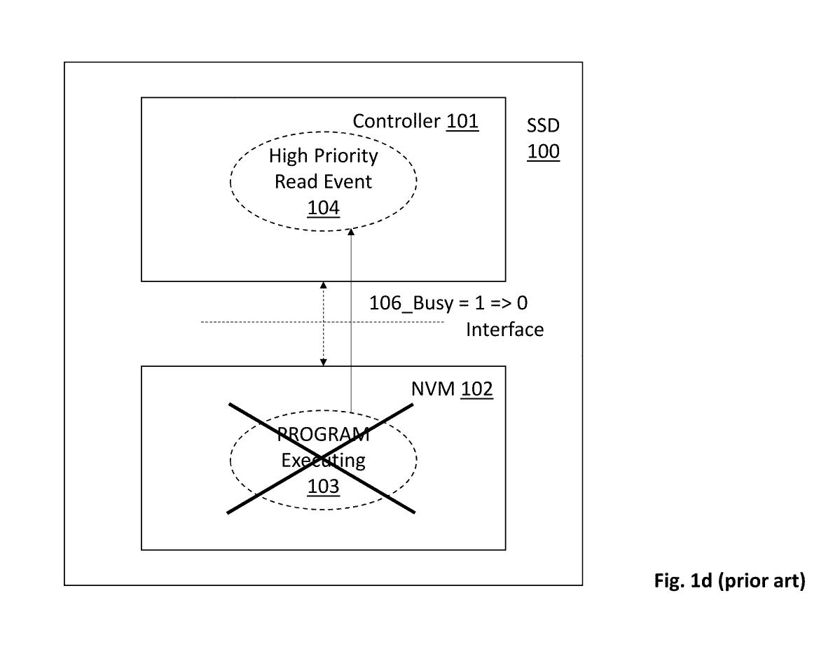

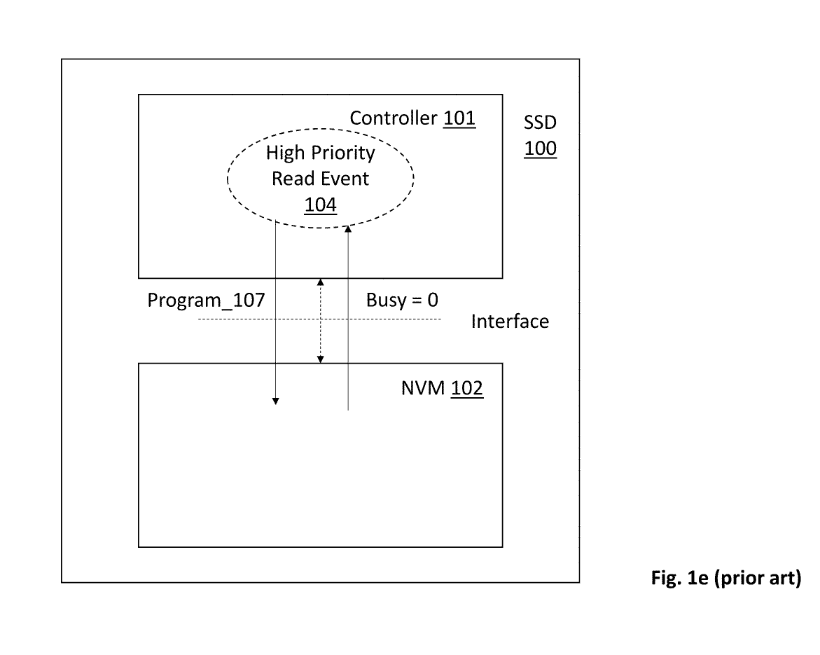

A problem concerns performing a high priority read that maps to an NVM within the SSD when the NVM is already engaged in some kind of activity (e.g., a write or “PROGRAM” operation). FIGS. 1a-1d show the problem in more detail. As observed in FIG. 1a, initially, the NVM 102 is engaged in a PROGRAM operation 103. For example, in the case of a PROGRAM, the controller 101 causes, e.g., one or more pages or blocks of information to be written into the NVM 102. For simplicity FIGS. 1a-1d show only one NVM 102 in the SSD 100. As is understood in the art, a typical SSD 100 includes multiple NVMs. Moreover, a PROGRAM, ERASE or READ command can target one or more NVMs within the SSD 100. For simplicity the example of FIGS. 1a-1d assumes that only one NVM 102 is targeted by the PROGRAM command being discussed.

Communication with the NVM 102 by the controller 101 to command or otherwise control the NVM 102 may include the writing to and/or reading from specific registers or memory in the controller 101 and/or writing to and/or reading from specific registers or memory within the NVM 102 that are reachable to the controller 101 by, e.g., an internal interface of the SSD 100 that exists between the controller 101 and NVM 102 (e.g., an Open NAND Flash Interface (ONFI) interface, a proprietary interface, etc.) to communicatively couple the controller 101 and NVM 102.

One such register or memory location may indicate whether or not the NVM 102 is “ready” to receive a next command. That is, for example, if the NVM 102 is free to accept a next command from the controller 101, the NVM 102 sets the “ready” bit to a 1. By contrast, if the NVM 102 is currently executing a command that it previously accepted from the controller 101, the NVM's “ready” bit is a 0 and remains in that state until the executing command is completed. When the “ready” bit is 0, the controller 101 refrains from issuing a next command to the NVM 102.

As observed in FIG. 1b, the controller 101 becomes aware 104 of a situation that requires an immediate read from the NVM 102 (e.g., the controller receives a high priority read from the host). However, because the NVM 102 is currently executing the PROGRAM task 103, its “ready” bit is set to 0 and the controller 101 cannot immediately send a READ command to the NVM 102.

As observed in FIG. 1c, the controller 101 issues a Program_Suspend command 105 to the NVM 102 and then starts a timer or otherwise idles itself while waiting for the NVM 102 to suspend operation. As observed in FIG. 1d, the NVM 102 eventually suspends the PROGRAM operation it was executing when the controller 101 issued the Program_Suspend command. As observed in FIG. 1d, the NVM 102 signifies 106 to the controller 101 (with a busy=0 signal) that the NVM 102 is now able to receive the high priority read request. In response, as observed in FIG. 1e, the controller 101 issues the high priority read request 107 to the NVM 102. The NVM 102 then services the high priority read command 107 from the controller 101.

A problem with the aforementioned sequence is the involvement/oversight of the controller 101. Specifically, there is a handshake-like communication between the controller 101 and NVM 102 that the controller 101 has to oversee and manage. The controller 101 has to further idle itself or otherwise devotes resources to monitoring the NVM 102 between the time it sends the Program_Suspend command 105 and the time it sends the high priority read command 107. In the interim, the controller 101 is less able to perform other tasks because it is monitoring the status of the NVM 102.

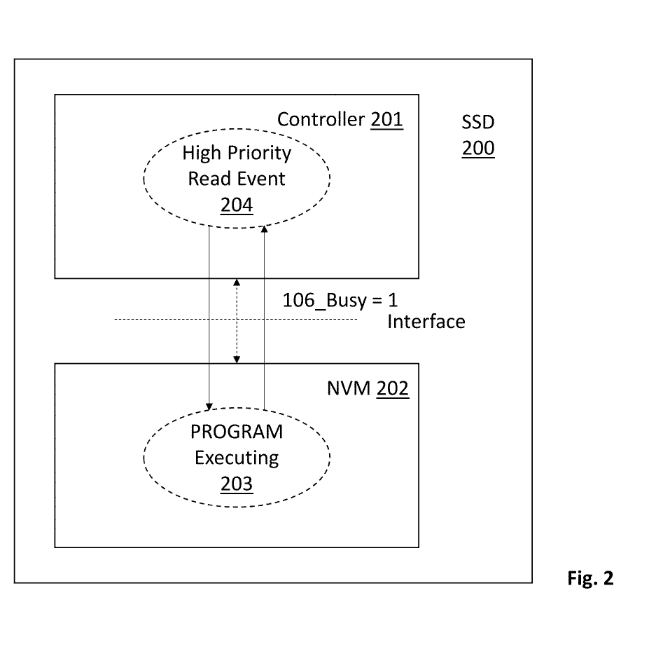

A solution to the problem, as observed in FIG. 2, is to incorporate functionality into the NVM 202 that permits the NVM 202 to accept a high priority read command from the controller 201 when the NVM 202 is busy. With such functionality, the controller 201 does not have to first send a Program_Suspend command or wait until the NVM 202 is free before sending the high priority read command to the NVM 202. Rather, as observed in FIG. 2, in the improved approach, the controller 201 can detect that the NVM 202 is busy but nevertheless immediately sends a high priority read request to the NVM 202. The controller 201 is then free to handle other tasks while the NVM 202 handles the high priority read command.

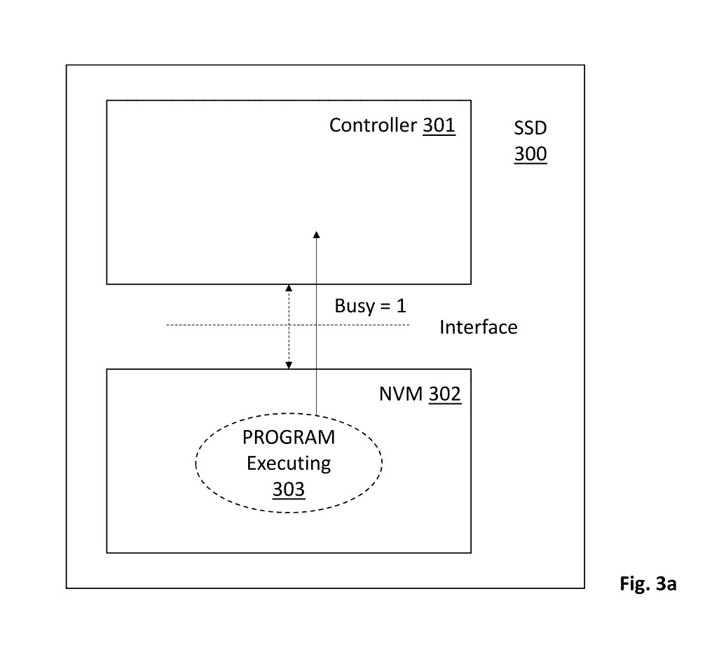

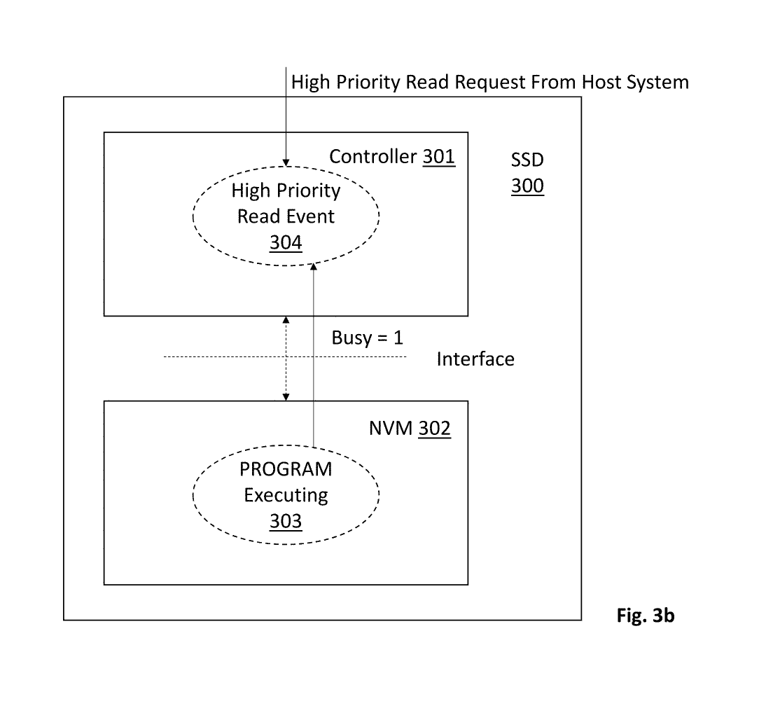

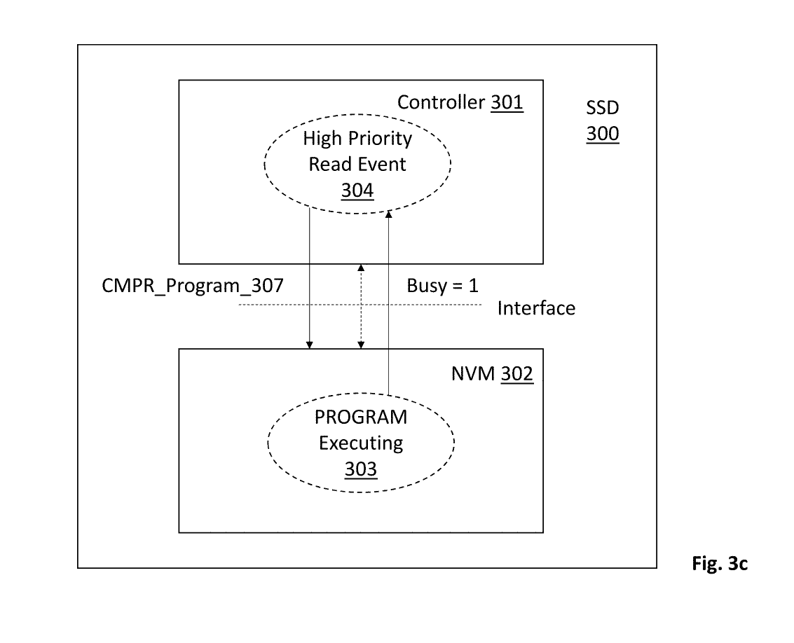

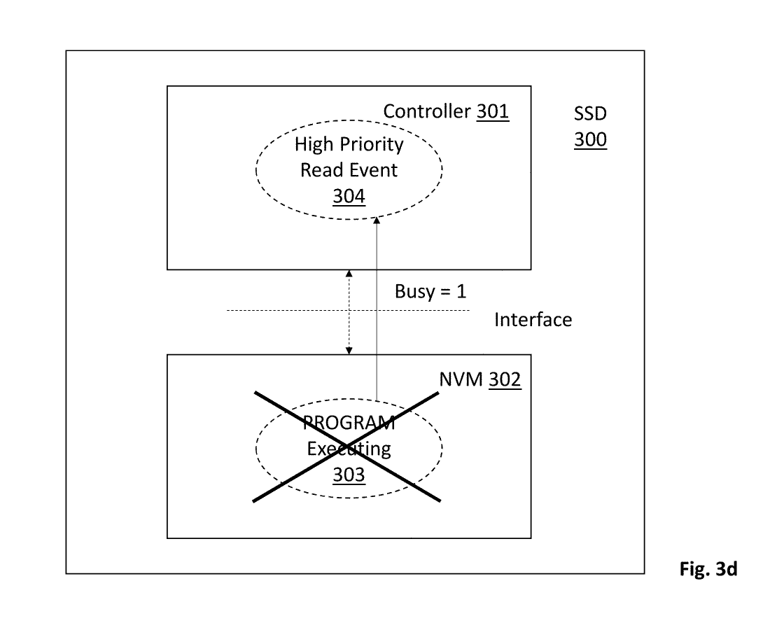

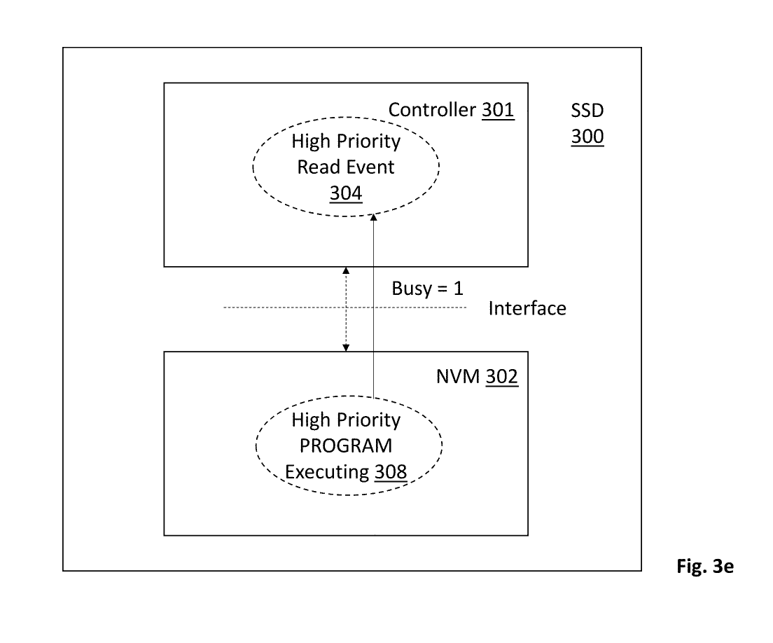

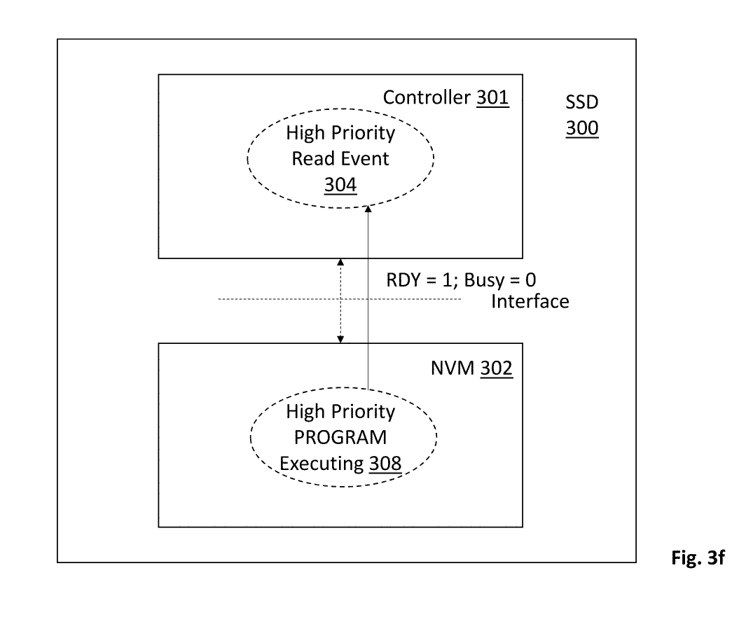

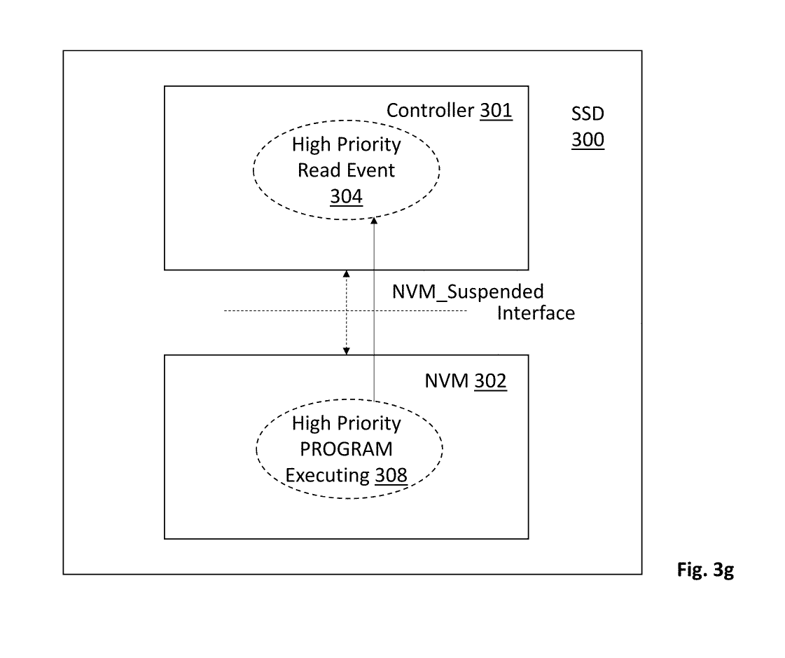

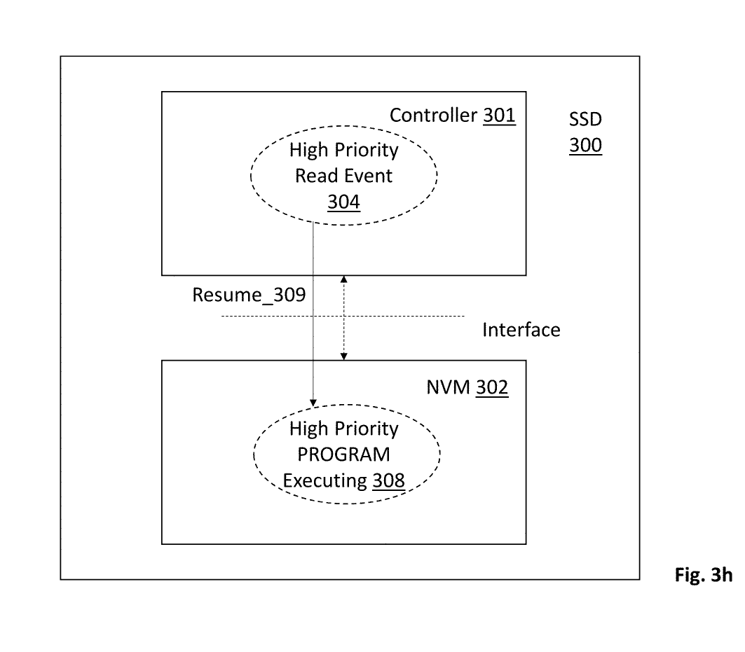

FIGS. 3a through 3f show an embodiment of the improved process. As observed in FIG. 3a, initially, the NVM 302 is engaged in a PROGRAM operation. As observed in FIG. 3b, the controller 301 becomes aware of a situation that requires an immediate read 304 from the NVM (e.g., a high priority read is received from the host platform).

In response, as observed in FIG. 3c, the controller 301 immediately issues a “CMPR_Read” command 307 to the NVM 302 (also referred to as an “AUTO PROGRAM SUSPEND” command). The CMPR_Read command 307 includes a physical address that is used to fetch the specifically desired read data from the NVM 302. The reception of the CMPR_Read command 307 by the NVM 302 causes the NVM to stop the write activity. In an embodiment, the partially written portion of the suspended PROGRAM operation is kept in the NVM 302 as valid information (where the controller 301 keeps the valid/invalid data tracking information). Alternatively, it is marked invalid and the resumption of the suspended PROGRAM includes re-marking it as valid, or, completely re-writing the entire PROGRAM content from the controller's cache.

As observed in FIGS. 3d and 3e, once the pre-existing PROGRAM operation 303 has been suspended, the NVM 302 automatically follows with the high priority read operation 308. The NVM 302 may perform the high priority read without further communication to the controller 301, or, formally report to the controller 301 (e.g., through the SSD's internal interface) that the PROGRAM operation has been formally suspended.

As observed in FIG. 3f, the NVM 302 completes the high priority read operation. Upon completion of the high priority read by the NVM 302, the read information is made available to the controller 301. In an embodiment, in order to inform the controller 301 that the high priority read data is available, the busy bit (BSY) is set to 0 and a ready bit (RDY) is set to 1 in register space of the NVM 302 and/or controller 301. In a further embodiment, two bits are used to signify a read operation is complete, e.g., RDY and ARDY. The NVM first sets RDY to 1 and then sets ARDY to 1. The controller 301 is then free to access the high priority data from the NVM 302 and, e.g., move it to the controller's local memory.

In a further embodiment, as observed in FIG. 3g, the NVM 302 does not automatically continue or restart the previous, suspended PROGRAM operation. Rather, the NVM 302 waits for the controller 301 to send an affirmative, subsequent command that the suspended Program operation should be continued and completed. In an embodiment, the NVM 302 sets a status bit in register space of the NVM 302 and/or controller 301 that reflects the suspended status of the NVM 302 (e.g., an SR bit such as an SR[2] bit).

As observed in FIG. 3h, with notice that the NVM 302 has completed the high priority read operation and is now in a suspended state, the controller 301 can then issue a Program_Resume command 309 to the NVM 302 to cause the NVM 302 to resume the suspended PROGRAM operation 303. If the prior PROGRAM was suspended by leaving its previously written portion in place as valid data, execution of the Program_Resume command includes the controller 301 re-starting the flow of write information from the previous point of operation when suspension was invoked. By contrast, if the controller 301 declared the previously written information invalid as part of the suspension activity, the controller 301 reclassifies the data as valid and then proceeds to send the remainder of the data to the NVM 302. Alternatively, the entirety of the operation can be restarted from the beginning in which case the controller 301 resends the entire write amount to the NVM 302. In various embodiments, the high priority read information must be read from the NVM 302 before the NVM 302 can resume the suspended PROGRAM operation.

In an embodiment, if the NVM 302 happened to complete the prior PROGRAM operation before the high priority read command was formally received by the NVM 302, the NVM 302 instead does not affirmatively state that it is in a suspended state (e.g., an SR bit, such as an SR[2] bit is not set). As such, the controller 301 need not send a Program_Resume command. That is, the NVM 302 is simply ready to receive a next command, the controller 301 understands that the NVM 302 is ready to receive a next command (i.e., that the previous PROGRAM command in fact completed prior to execution of the high priority read) and, as such, issues the next command directly to the NVM 302.

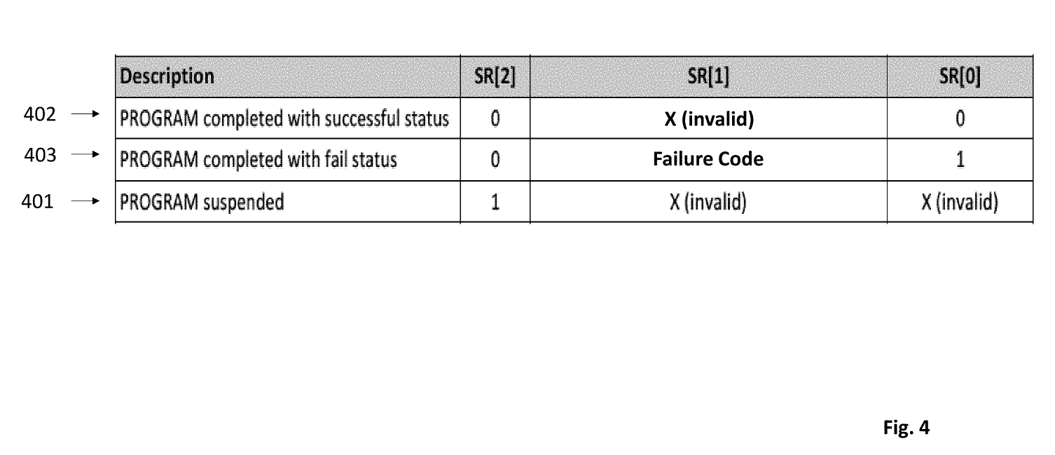

FIG. 4 shows an embodiment of the status of the SR[0] through SR[2] bits and their meaning after execution of a CMPR_Read. The bottom row 401 shows standard operation where the NVM returns in a suspended state, whereas row 402 shows the special case where the NVM happened to complete the PROGRAM before the CMPR_Read command was formally received by the NVM. The middle row shows another special case where an error has occurred in the execution of the high priority read.

In an embodiment, a parameter is established (which may be set in configuration register space of the NVM and/or controller) that sets the amount of time within which the NVM must suspend the interrupted operation and be ready to receive the high priority read command. If the NVM does not suspend the operation in the preset time an error flag is raised (e.g., by the NVM or the controller).

In various embodiments, the CMPR_Read command can only be issued by the controller to the NVM when the NVM is currently busy on another operation (NVM busy bit=1). If the NVM is not formally busy, the controller must issue a nominal read command to the NVM. As is known in the art, some flash NVM's reserve a region of storage space to act like a read-only-memory (ROM). The reserved region is referred to as a one-time-program (OTP) and an OTP PROGRAM is a command to write to the OTP region. In further embodiments, the CMPR_Read command cannot be issued during an OTP program. That is, a write to the OTP region cannot be suspended in favor of a high priority read.

Moreover, as is known in the art, an NVM may support different kinds of read operations. For example, NVMs may support an offset read. In the case of an offset read, the requested data starts at an offset from a base address. Moreover, certain NVM's can be configured to behave in a certain way if there is a problem with a read. For example, a read retry (RR) re-attempts a second read after a read that contains errors that error correction encoding within the NVM could not correct. A moving read retry (MRR) re-attempts a second read after a read that contains errors that error correction encoding could not correct, where, the second read uses a different read parameter (e.g., a different threshold voltage setting). In an embodiment, any read retry settings that are in place when the CMPR_Read command is issued remain in place for the high priority read (if read retry is enabled and the high priority read initially results in a bad read, the high priority read is retried).

In various embodiments, operations other than a PROGRAM can be suspended consistent with the above described process. For example, in one specific NVM embodiment at least both the PROGRAM and ERASE operations can be suspended in favor of a high priority read (CMPR_Read). In various embodiments, a CMPR_Read_Snap command is supported that returns less than a full block of information. That is, as is understood in the art, a nominal read typically includes a preset amount of information (e.g., multiple planes of data). A CMPR_Read corresponds to a full read operation. A CMPR_Read_Snap command will cause the NVM to read an amount specified in the command that is less than a full amount (e.g., one plane of data).

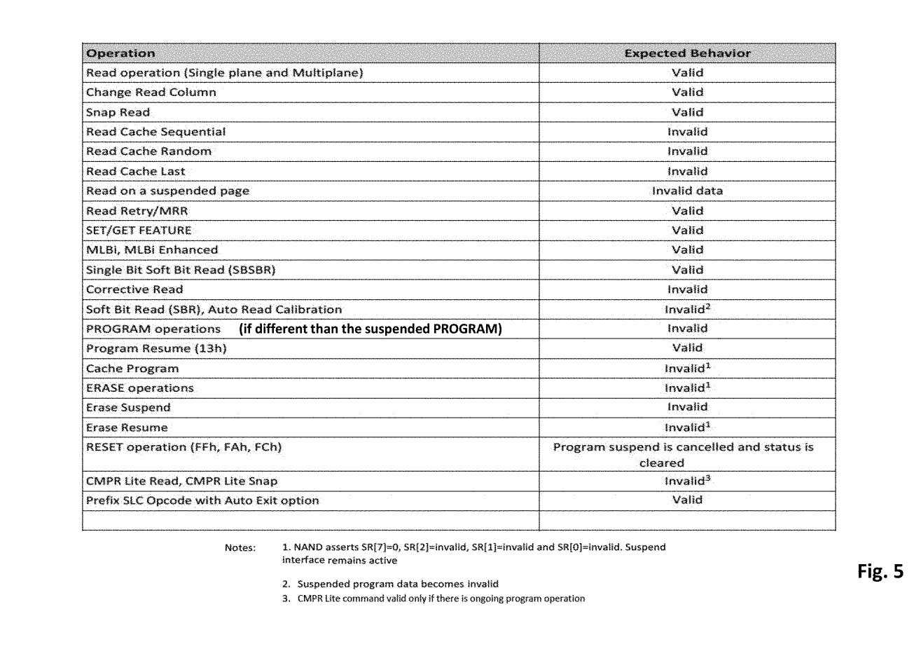

FIG. 5 shows an even further embodiment listing a complete set of commands that an NVM can execute, and, an indication if such operation can be executed after the NVM has returned in a suspended state after successful completion of a CMPR_Read (“valid”), or, an indication if such operation cannot be executed after the NVM has returned in a suspended state after successful completion of a CMPR_Read (“invalid”). Note that a large number of operations are valid. As such, the NVM need not immediately complete the suspended PROGRAM (or ERASE) operation after the successful CMPR_Read has been executed.

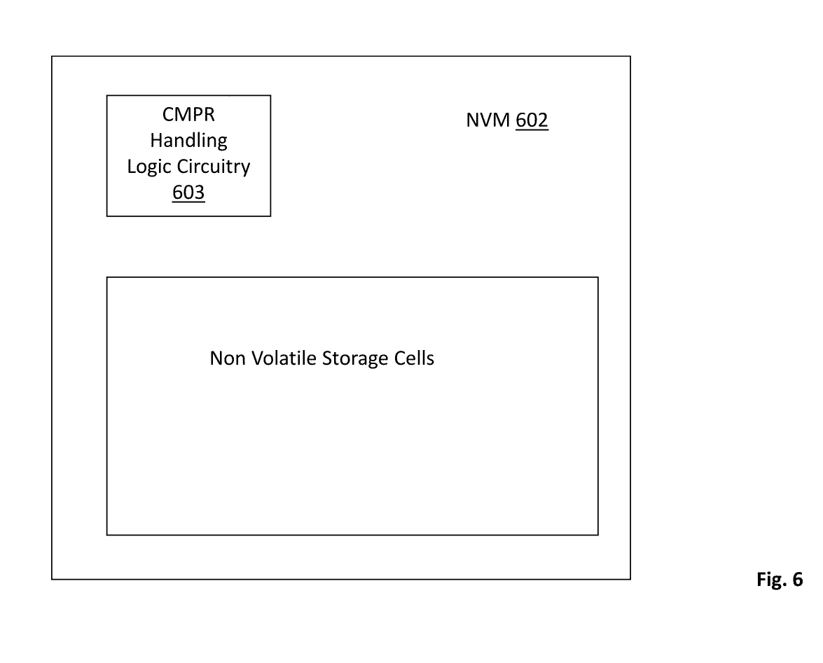

FIG. 6 shows a non-volatile memory (NVM) 602 having embedded logic circuitry 603 to handle CMPR_Read or CMPR_Read_Snap commands as described above. That is, logic circuitry 603 causes the NVM 602 to automatically suspend a current PROGRAM or ERASE operation in response to its reception of a CMPR_Read or CMPR_Read_Snap command, and, return in a suspended state if the prior PROGRAM/ERASE was interrupted, or, not return in a suspended state if the prior PROGRAM/ERASE was completed prior to its formal reception of the CMPR command.

Although the above description has referred to flash memory based SSDs specifically. In other embodiments the SSD may be composed of an emerging non volatile memory random access memory, such as, to name a few possibilities, a phase change based memory, a three dimensional crosspoint memory having non volatile storage cells, “write-in-place” non volatile main memory devices, memory devices having storage cells composed of chalcogenide, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc. Any of these technologies may be byte addressable so as to be implemented as a system memory in a computing system (also referred to as a “main memory”) rather than traditional block or sector based non volatile mass storage.

Emerging non volatile random access memory technologies typically have some combination of the following: 1) higher storage densities than DRAM (e.g., by being constructed in three-dimensional (3D) circuit structures (e.g., a crosspoint 3D circuit structure integrated in the metal wiring above the substrate of a semiconductor chip)); 2) lower power consumption densities than DRAM at least while idling (e.g., because they do not need refreshing); and/or, 3) access latency that is slower than DRAM yet still faster than traditional non-volatile memory technologies such as flash. The latter characteristic in particular permits various emerging non volatile memory technologies to be used in a main system memory role rather than a traditional mass storage role (which is the traditional architectural location of non volatile storage).

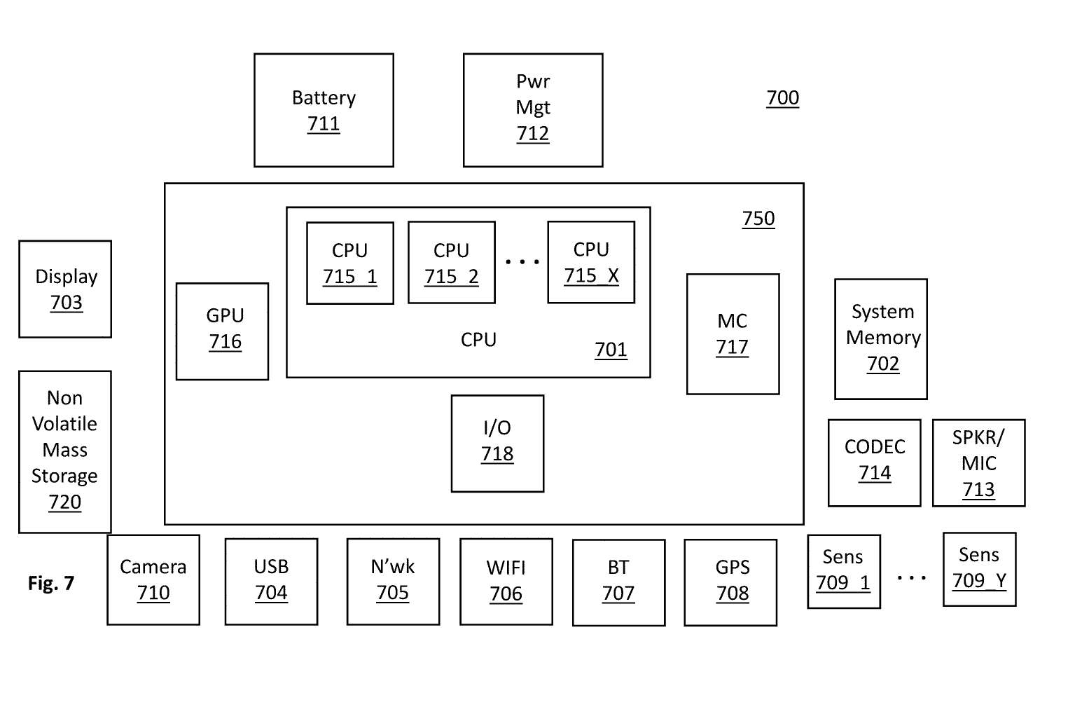

FIG. 7 provides an exemplary depiction of a computing system 700 (e.g., a smartphone, a tablet computer, a laptop computer, a desktop computer, a server computer, etc.). As observed in FIG. 7, the basic computing system 700 may include a central processing unit 701 (which may include, e.g., a plurality of general purpose processing cores 715_1 through 715_X) and a main memory controller 717 disposed on a multi-core processor or applications processor, system memory 702, a display 703 (e.g., touchscreen, flat-panel), a local wired point-to-point link (e.g., USB) interface 704, various network I/O functions 705 (such as an Ethernet interface and/or cellular modem subsystem), a wireless local area network (e.g., WiFi) interface 706, a wireless point-to-point link (e.g., Bluetooth) interface 707 and a Global Positioning System interface 708, various sensors 709_1 through 709_Y, one or more cameras 710, a battery 711, a power management control unit 712, a speaker and microphone 713 and an audio coder/decoder 714.

An applications processor or multi-core processor 750 may include one or more general purpose processing cores 715 within its CPU 701, one or more graphical processing units 716, a memory management function 717 (e.g., a host side memory controller) and an I/O control function 718. The general purpose processing cores 715 typically execute the system and application software of the computing system. The graphics processing unit 716 typically executes graphics intensive functions to, e.g., generate graphics information that is presented on the display 703. The I/O control function may include a peripheral control hub or other circuit having an interface to a non volatile mass storage device 720 (e.g., an interface to a solid state drive (SSD), an interface to a disk drive, etc.). The mass non volatile storage device 720 may be an SSD described above that supports a high priority read request without the host having to first suspend the SSD's current operation.

The memory control function 717 interfaces with the system memory 702 to write/read data to/from system memory 702. The system memory may be implemented as a multi-level system memory. The memory controller function may include intelligence that limits the amount of dirty data in a higher, volatile level of memory to allow for cost-effective and/or configurable battery powered back-up of the volatile level in case of a power loss event as discussed at length above.

Each of the touchscreen display 703, the communication interfaces 704-707, the GPS interface 708, the sensors 709, the camera(s) 710, and the speaker/microphone codec 713, 714 all can be viewed as various forms of I/O (input and/or output) relative to the overall computing system including, where appropriate, an integrated peripheral device as well (e.g., the one or more cameras 710). Depending on implementation, various ones of these I/O components may be integrated on the applications processor/multi-core processor 750 or may be located off the die or outside the package of the applications processor/multi-core processor 750. The power management control unit 712 generally controls the power consumption of the system 700.

Embodiments of the invention may include various processes as set forth above. The processes may be embodied in machine-executable instructions. The instructions can be used to cause a general-purpose or special-purpose processor to perform certain processes. Alternatively, these processes may be performed by specific/custom hardware components that contain hardwired logic circuitry or programmable logic circuitry (e.g., FPGA, PLD) for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a solid state drive having a controller and a non volatile memory, the non volatile memory to receive a read command from the controller while the controller is performing another operation and without the controller sending a suspend command to the non volatile memory to suspend the non volatile's performing of the another operation.

2. The apparatus of claim 1 where the read command is able to be received by the non volatile when a status register for the non volatile memory indicates that the non volatile memory is busy.

3. The apparatus of claim 1 where the controller and non volatile memory communicate over an ONFI interface.

4. The apparatus of claim 1 wherein the non volatile memory suspends itself upon completion of a read operation performed in response to the read command.

5. The apparatus of claim 4 wherein the suspension of the non volatile memory is reported to the controller.

6. The apparatus of claim 5 wherein the suspension is reported with an SR bit.

7. The apparatus of claim 1 wherein the non volatile memory is, if a read performed in response to the read command results in an uncorrectable error, to perform a read retry if the non volatile memory is configured to perform a read retry when the read command was issued by the controller to the non volatile memory.

8. The apparatus of claim 1 wherein the operation is at least one of a program operation and an erase operation.

9. An apparatus, comprising:
a) a host comprising:
i) plurality of processing cores;
ii) a peripheral control hub;
b) an NVMe link coupled to the peripheral control hub;
c) a solid state drive coupled to the peripheral control hub through the NVMe link, the solid state drive having a having a controller and a non volatile memory, the non volatile memory to receive a read command from the controller while the non volatile memory is performing another operation and without the controller sending a suspend command to the non volatile memory to suspend the non volatile memory's performing of the another operation.

10. The apparatus of claim 9 where the read command is able to be received by the non volatile memory when a status register for the non volatile memory indicates that the non volatile memory is busy.

11. The apparatus of claim 9 where the controller and non volatile memory communicate over an ONFI interface.

12. The apparatus of claim 9 wherein the non volatile memory suspends itself upon completion of a read operation performed in response to the read command.

13. The apparatus of claim 12 wherein the suspension of the non volatile memory is reported to the controller.

14. The apparatus of claim 13 wherein the suspension is reported with an SR bit.

15. The apparatus of claim 9 wherein the non volatile memory is, if a read performed in response to the read command results in an uncorrectable error, to perform a read retry if the non volatile memory is configured to perform a read retry when the read command was issued by the controller to the non volatile memory.

16. The apparatus of claim 9 wherein the operation is at least one of a program operation and an erase operation.

17. A method performed by a non volatile memory, comprising:
receiving a first command from a controller to perform an operation;
receiving a second command from the controller to perform a read operation, where, the controller does not send a third command to suspend the operation between the first and second commands.

18. The method of claim 17 wherein a status bit in register space for the non volatile memory indicates the non volatile memory is busy when the second command is received by the non volatile memory.

19. The method of claim 17 further comprising the non volatile memory suspending itself upon the read operation being completed.

20. The method of claim 19 wherein a suspended state of the non volatile memory is reported through to the controller upon the read operation being completed.
